(19) United States
(12) Patent Application Publication
(10) Pub. No.: US 2026/0096589 A1
(43) Pub. Date: Apr. 9, 2026

(54) DRUM ROASTER FOR ROASTING BEANS

(71) Applicant: PROBAT SE, Emmerich (DE)

(72) Inventors: THOMAS KOZIOROWSKI, MUELHEIM AN DER RUHR (DE); DIETMAR WISSEN, REES (DE)

(73) Assignee: PROBAT SE, Emmerich (DE)

(21) Appl. No.: 19/110,437

(22) PCT Filed: Sep. 19, 2023
(86) PCT No.: PCT/EP2023/075710

§ 371 Date: Mar. 11, 2025

(30) Foreign Application Priority Data
Sep. 20, 2022 (DE) 10 2022 124 079.7

(51) Int. Cl. A23N 12/10; A23N 12/12

(52) U.S. Cl. CPC A23N 12/10; A23N 12/125

(57) ABSTRACT

A drum roaster for roasting beans. The drum roaster includes a housing assembly in which a roasting drum for receiving the beans is rotatably supported, a drive device for rotating the roasting drum, and a heating assembly for heating the beans at least via a heating air. The heating assembly includes an electric heating element for heating a feed air, a suction fan for extracting the heating air out of the roasting drum, and a feed air fan to supply the feed air.

The electric heating element is arranged in a heating tube upstream of the roasting drum as seen in a flow direction of the heating air. The suction fan is arranged downstream of the roasting drum as seen in the flow direction of the heating air. The feed air fan is arranged upstream of the electric heating element as seen in a flow direction of the feed air.

### CROSS REFERENCE TO PRIOR APPLICATIONS

This application is a U.S. National Phase application under 35 U.S.C. § 371 of International Application No. PCT/EP2023/075710, filed on Sep. 19, 2023 and which claims benefit to German Patent Application No. 10 2022 124 079.7, filed on Sep. 20, 2022. The International Application was published in German on Mar. 28, 2024 as WO 2024/061858 A1 under PCT Article 21(2).

### FIELD

The present invention is directed to a drum roaster for roasting beans, the drum roaster comprising a housing assembly in which a roasting drum for receiving the beans is rotatably supported, wherein a drive device for rotating the roasting drum and a heating assembly for heating the beans at least via heating air are provided, wherein the heating arrangement comprises at least one electric heating element, which is arranged in a heating tube upstream of the roasting drum, as viewed in the flow direction of the heating air, for heating supply air, and a suction fan, which is arranged downstream of the roasting drum, as viewed in the flow direction of the heating air, for extracting the heating air from the roasting drum.

### BACKGROUND

Such drum roasters are well known in the art and are in particular used as so-called small or shop roasters in smaller roasting plants or in shops or cafés. An example thereof is the drum roaster described in DE 20 2017 002 951 U1 where an electric heating element, such as an electric heating air generator with ceramic heating resistors, is provided, the heating air from which is sucked into the roasting drum by a suction fan. The generation of heating air is highly dependent on ambient conditions with an electric heating element having a suction fan. This can cause the low-pressure conditions in the roasting drum to fluctuate considerably, which can lead to undesirable roasting results. It should be noted that it is known from the field of household roasters (see, for example, EP 2 179 665 A1, roasting quantity 0.5 kg-2 kg) to place a blower in front of an electric heating element in order to feed heating air into a roasting drum. However, the heating air is then even more difficult to control than in the above-mentioned embodiment with a suction fan.

### SUMMARY

An aspect of the present invention is therefore to avoid the above-mentioned disadvantage in a simple and cost-effective manner.

In an embodiment, the present invention provides a drum roaster for roasting beans. The drum roaster includes a housing assembly in which a roasting drum for receiving the beans is rotatably supported, a drive device for rotating the roasting drum, and a heating assembly for heating the beans at least via a heating air. The heating assembly comprises at least one electric heating element for heating a feed air, a suction fan for extracting the heating air out of the roasting drum, and a feed air fan which is configured to supply the feed air. The at least one electric heating element is arranged in a heating tube upstream of the roasting drum as seen in a flow direction of the heating air. The suction fan is arranged downstream of the roasting drum as seen in the flow direction of the heating air. The feed air fan is arranged upstream of the at least one electric heating element as seen in a flow direction of the feed air.

### BRIEF DESCRIPTION OF THE DRAWINGS

The present invention is described in greater detail below on the basis of embodiments and of the drawings in which:

FIG. 1 shows a partially sectioned side view of a drum roaster according to the present invention;

FIG. 2 shows a detailed view of an electric heating element and a feed air fan fluidically connected thereto;

FIG. 3 shows a schematic view of a first control circuit; and

FIG. 4 shows a schematic view of a second control circuit.

### DETAILED DESCRIPTION

The present invention provides a heating assembly comprising a feed air fan that is arranged upstream of the electric heating element, as seen in the flow direction of the feed air. This provides a uniform flow of supply air into the roasting drum in a particularly simple and cost-effective manner. The roasting process can be controlled by the user in a very simple manner. A reliable cooling of the electric heating element is also provided in all operating situations. The feed air fan can, for example, be configured as a side channel fan.

A ceramic heating element is configured as an electric heating element that is particularly easy and inexpensive to manufacture and which can also be cooled in a simple manner. Channels are in this case provided in a ceramic element, in which heating rods are arranged. The supply air flows through the channels.

An embodiment of the present invention comprises a control device, at least for the heating assembly, which can, for example, at least control the heating process.

An embodiment of the present invention is characterized in that a collecting container for the supply air conveyed by the supply air fan can, for example, be provided at the electric heating element. This collecting container essentially serves to smooth the supply air flow. A minimum flow through the electric heating element can be provided by the fact that a pressure monitor is provided which is fluidically connected to the heating tube.

A frequency converter can, for example, be provided for controlling the feed air fan. This enables an energy-efficient operation and a simple speed control with a constant air flow of the feed air fan.

A temperature sensor in the heating tube makes it possible to easily monitor the temperature of the electric heating element. If the temperature of the electric heating element is too high, the temperature sensor detects the too high temperature and the electric heating element is shut down for safety reasons.

In an embodiment of the present invention, a protective temperature limiter can, for example, be provided in the heating tube, which, in the event of overheating, switches off the heating element and can generate an error message.

In an embodiment of the present invention, the electric heating element can, for example, comprise a clocked power supply as a first control circuit. This provides a simple control of the heating energy and, in turn, a simple control of the roasting process. For this purpose, a semiconductor switch with a PWM signal at the input can be provided for the clocked power supply, which can be determined by a PID controller, wherein a comparison of a setpoint heating air temperature with an actual heating air temperature is carried out at the input of the PID controller in the electric heating element.

A second control circuit can be provided for setting the temperature according to a recipe during automatic roasting, in which a comparison of a setpoint recipe temperature and an actual recipe temperature takes place at the input of a PID controller. The roasting, heating air and/or exhaust air temperature can, for example, be considered as the recipe temperature.

The present invention is explained further below via the drawings.

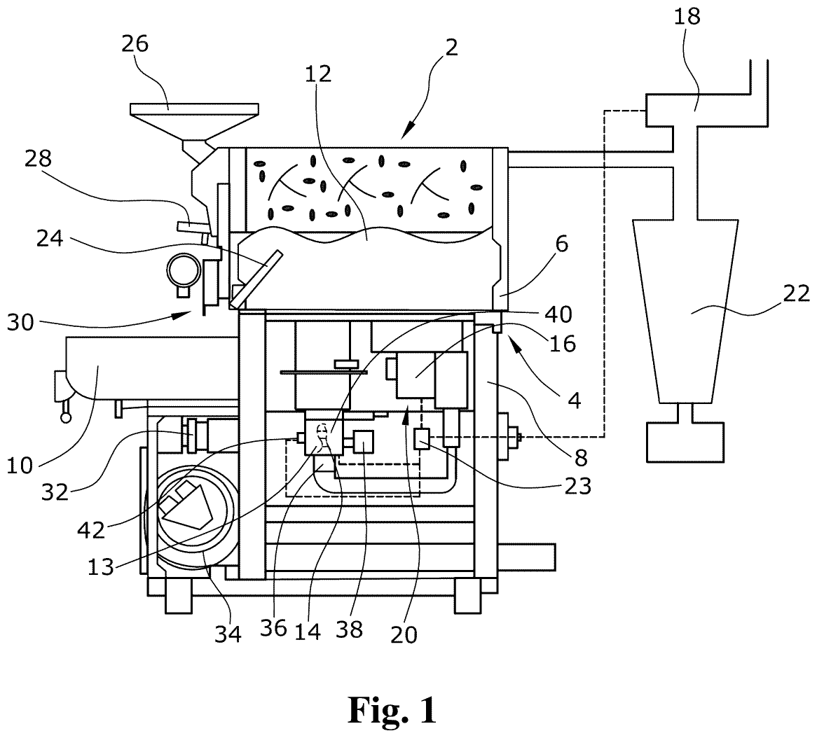

FIG. 1 shows a typical drum roaster 2 as a shop roaster. The drum roaster 2 comprises a housing assembly 4, which essentially comprises a drum housing part 6 and a base housing part 8. In the interest of clarity, the base housing part 8 is here open, that is, without cover panels, as shown. The drum housing part 6 is placed on the base housing part 8, wherein the base housing part 8 comprises a collecting container 10 for roasted beans. In and on the drum housing part 6, in a manner known per se, are a roasting drum 12, which is shown here in a partial cross-section, as well as a drive mechanism (which is not shown in further detail) for rotating the roasting drum 12, and an electric heating element 14, which is shown here only schematically, in part in cross-section, for heating the heating air to be supplied to the roasting drum 12, which is configured as a ceramic heating element. The heating tube 13 with the electric heating element 14, together with a feed air fan 16 and a suction fan 18, define a heating assembly 20 that provides the supply of feed air to the roasting drum 12 as heating air and the removal of exhaust air through a cyclone 22 of a known type, and is controlled by a control device 23. The heat transfer to the beans takes place through direct contact with the heating air by convection and through the roasting drum 12 by conduction. A display 24 arranged at the drum housing part 6 serves here as an input and display panel for the user.

A bean inlet funnel 26, a sample extractor arrangement 28, and a bean outlet arrangement 30, which also includes the collecting container 10, are also shown in FIG. 1. A mixing drive device 32 for a mixing device (which is not shown in more detail) is rotatably supported in the collecting container 10, and a cooling air fan 34 for supplying cooling air to the collecting container 10, are provided below the collecting container 10.

As already mentioned above, a feed air fan 16 is provided for the supply of feed air, which, viewed in the direction of flow of the feed air, is arranged upstream of the electric heating element 14. A collecting container 36 is also provided at the heating tube 13 between the feed air fan 16 and the heating tube 13 with the electric heating element 14, which causes the feed air flow to settle. A pressure monitor 38 is in fluidic connection with the heating tube 13. The pressure monitor 38 monitors the pressure in the heating tube 13 and thereby provides a minimum flow and thus a reliable cooling of the electric heating element 14. A frequency converter (which is not shown in more detail) for controlling the feed air fan 16 makes an energy-efficient operation and a simple speed control possible.

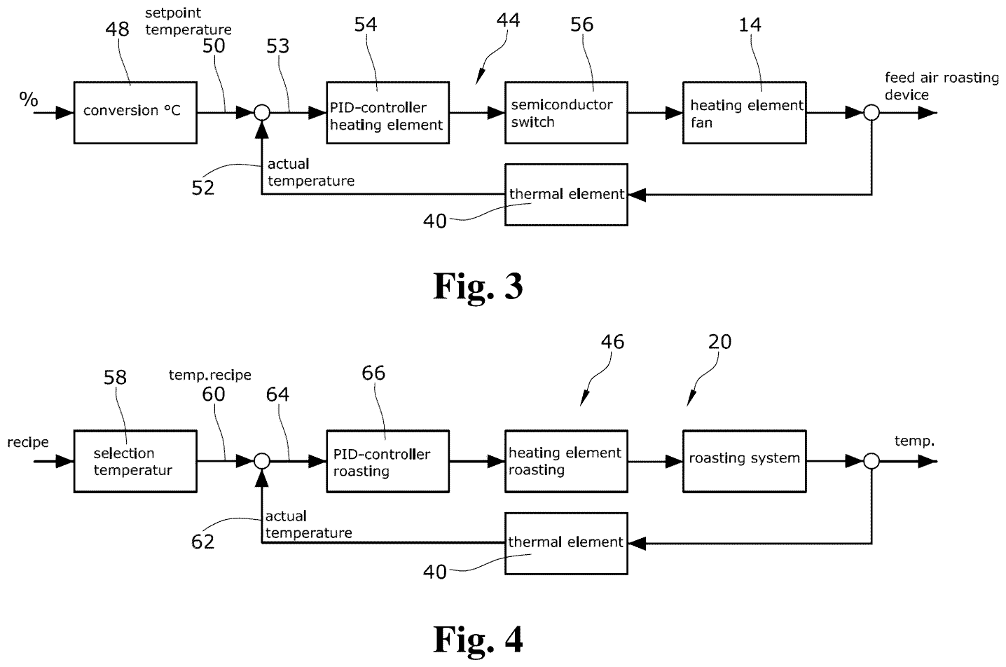

A temperature sensor 40 is provided for monitoring the heating air temperature in the heating tube 13, which extends into the heating tube 13 and monitors the temperature. A protective temperature limiter 42 is also provided at the heating tube 13. The protective temperature limiter 42 immediately switches off the electric heating element 14 if a temperature limit is exceeded. The pressure monitor 38, the temperature sensor 40, and the protective temperature limiter 42, are connected to the control device 23 via the heating assembly 20 using control technology. To provide for a simple control of the heating energy by the electric heating element 14, a clocked power supply is provided that constitutes a first control circuit 44 (see FIG. 3). A second control circuit 46 is provided for recipe-based temperature control during automatic roasting and is described in the context of FIG. 4.

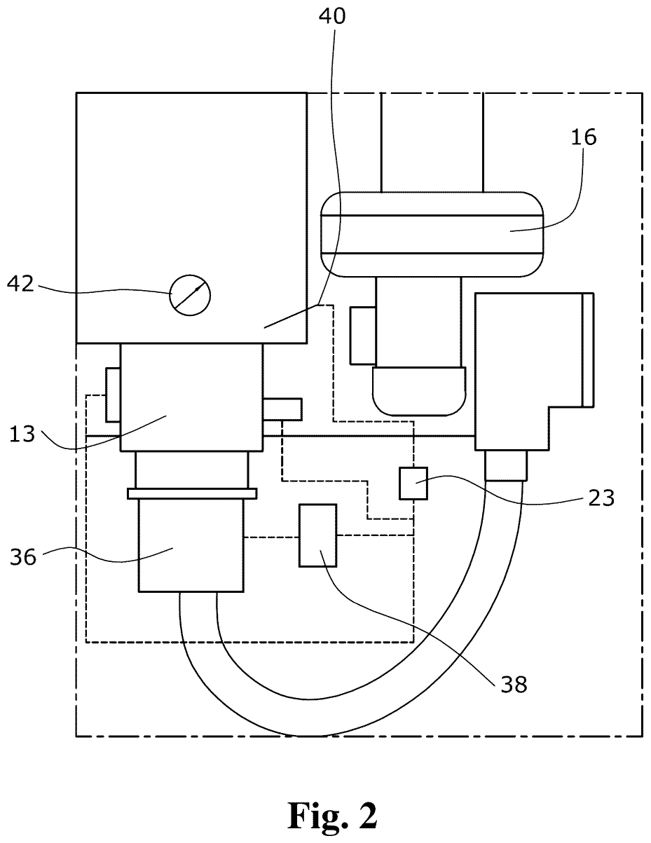

FIG. 2 shows again in detail the heating tube 13 with the upstream collecting container 36 and the feed air fan 16. The pressure monitor 38, the temperature sensor 40, and the protective temperature limiter 42, can also here clearly be seen.

FIG. 3 shows a schematic view of the first control circuit 44 for the clocked power supply of the electric heating element 14, which is implemented in the control device 23. A roasting process stored in the control device 23 specifies a percentage of the maximum heating power, which is converted in a block 48 into a setpoint recipe temperature 50 in ° C. and compared with an actual recipe temperature 52. A differential value 53 serves as the input signal of a PID controller 54 of the electric heating element 14 and is supplied as a PWM signal to a semiconductor switch 56. The semiconductor switch 56 then generates the clocked power supply of the electric heating element 14, whose actual temperature, in this case the actual recipe temperature 52, is monitored by the temperature sensor 40.

FIG. 4 shows a schematic view of the second control circuit 46 for setting the recipe temperature during an automatic roasting process. A roasting process stored in the control device 23 selects a setpoint recipe temperature 60 from a recipe in a block 58, which is compared with an actual recipe temperature 62. A differential value 64 serves as the input signal of a PID controller 66 that controls the heating assembly 20. The actual recipe temperature 62 is also monitored here by the temperature sensor 40. The roasting, heating air and/or exhaust air temperature can serve as the recipe setpoint temperature 60 or actual recipe temperature 62.

The present invention is not limited to embodiments described herein; reference should be had to the appended claims.

### LIST OF REFERENCE NUMERALS

2 Drum roaster
4 Housing assembly
6 Drum housing part
8 Base housing part
10 Collecting container
12 Roasting drum
13 Heating tube
14 Electric heating element
16 Feed air fan
18 Suction fan
20 Heating assembly
22 Cyclone
23 Control device
24 Display
26 Bean inlet funnel
28 Sample extractor arrangement
30 Bean outlet arrangement
32 Mixing drive device
34 Cooling air fan
36 Collecting container
38 Pressure monitor
40 Temperature sensor
42 Protective temperature limiter
44 First control circuit
46 Second control circuit
48 Block
50 Setpoint recipe temperature
52 Actual recipe temperature
53 Differential value/input signal
54 PID controller
56 Semiconductor switch
58 Recipe in a block
60 Setpoint recipe temperature
62 Actual recipe temperature
64 Differential value/input value
66 PID controller

What is claimed is:

1-12. (canceled)

13. A drum roaster for roasting beans, the drum roaster comprising:
a housing assembly in which a roasting drum for receiving the beans is rotatably supported;
a drive device for rotating the roasting drum; and
a heating assembly for heating the beans at least via a heating air, the heating assembly comprising,
at least one electric heating element for heating a feed air, the at least one electric heating element being arranged in a heating tube upstream of the roasting drum as seen in a flow direction of the heating air,
a suction fan for extracting the heating air out of the roasting drum, the suction fan being arranged downstream of the roasting drum as seen in the flow direction of the heating air, and
a feed air fan which is configured to supply the feed air, the feed air fan being arranged upstream of the at least one electric heating element as seen in a flow direction of the feed air.

14. The drum roaster as recited in claim 13, wherein the at least one electric heating element is configured as a ceramic heating element.

15. The drum roaster as recited in claim 13, further comprising:
a collecting container for the feed air supplied by the feed air fan, the collecting container being arranged at the electric heating element.

16. The drum roaster as recited in claim 13, further comprising:
a frequency converter for controlling the feed air fan.

17. The drum roaster as recited in claim 13, further comprising:
a control device which is configured to control at least the heating assembly.

18. The drum roaster as recited in claim 17, further comprising:
a pressure monitor which is fluidically connected to the heating tube.

19. The drum roaster as recited in claim 17, further comprising:
a temperature sensor which is arranged in the heating tube.

20. The drum roaster as recited in claim 17, further comprising:
a protective temperature limiter which is arranged in the heating tube.

21. The drum roaster as recited in claim 17, wherein the at least one electric heating element comprises a clocked power supply as a first control circuit.

22. The drum roaster as recited in claim 21, further comprising:
a PID controller which comprises an input at which a setpoint temperature of the heating air is compared with an actual temperature of the heating air in the at least one electric heating element so as to determine a differential value as an input signal; and
a semiconductor switch for the clocked power supply,
wherein,
the input signal is supplied by the PID controller to an input of the semiconductor switch as a PWM signal.

23. The drum roaster as recited in claim 21, further comprising:
a second control circuit for setting a recipe temperature setting during an automatic roasting process,
wherein,
the second control circuit is configured to compare a setpoint recipe temperature with an actual recipe temperature at an input of a PID controller.

24. The drum roaster as recited in claim 23, wherein at least one of a roasting temperature, a heating air temperature and an exhaust air temperature is the actual recipe temperature.
